(19) United States
(12) Patent Application Publication
(10) Pub. No.: US 2007/0294094 A1
(43) Pub. Date: Dec. 20, 2007

(54) Methods of customizing, licensing and sustaining a technology option to meet a customer requirement

(75) Inventors: Walter Alessandrini, Elgin, SC (US); George Larry Wilson, Columbia, SC (US); Robert P. Freese, Pittsboro, NC (US); Jason W. Williamson, Cayce, SC (US); John C. Blackburn, Charleston, SC (US); Robert T. Fletcher, Columbia, SC (US)

Correspondence Address: DORITY & MANNING, P.A., POST OFFICE BOX 1449, GREENVILLE, SC, 29602-1449, US

(73) Assignee: Ometric Corporation

(21) Appl. No.: 11/471,115

(22) Filed: Jun. 20, 2006

(51) Int. Cl. G06Q 10/00; G06Q 30/00

(52) U.S. Cl. 705/1

(57) ABSTRACT

Methods of licensing state-of-the-art technology, such as an optical analysis system and components thereof, include assessing a technology requirement of a customer, such as a pharmaceutical, food or chemical industry customer; pricing the optical analysis system to meet the technology requirement; testing the optical analysis system to meet the technology requirement; licensing the optical analysis system based on the pricing thereof for a predetermined period of time; and maintaining the optical analysis system for the predetermined period of time.

### BACKGROUND OF THE INVENTION

In an era of rapid technology innovation and higher cost of money, investments in capital equipment are less attractive. Continuous product advances accelerate obsolescence of purchased equipment. Resources are wasted in installation and training as new equipment and products replace obsolete equipment, and cash outlays become more frequent to stay on top of the technology curve. Over time, cost of immobilized capital and service contract expenses can result in multifold increases of the original price paid for capital equipment. Moreover, there is substantial risk that once capital is committed to purchase new equipment, the purchased equipment may not meet expectations.

Optical spectroscopy, for instance, relies on relatively sophisticated equipment for measuring chemicals in many applications. Specifically, due to its relatively non-invasive, non-destructive qualities, optical spectroscopy is employed by a variety of industries such as pharmaceutical, chemical, oil & gas, and food & beverage industries. Modern production controls in these industries require real-time measurement of compound concentrations throughout manufacturing processes to ensure final product quality. However, conventional optical spectrometers can be inherently slow and require significant computer support and costly chemometric resources to provide reliable, actionable results. In many cases, complicated sampling of production material is necessary to perform lab analysis. The overall measurement process is time consuming and resource intensive.

Some industries have attempted to move optical spectroscopy out of the laboratory and to their production lines. However, the challenges of applying laboratory grade instruments to an industrial processing line are not trivial. In many cases, spectrometers are bulky and delicate, and designed for lab environments, not for production floors. Moreover, a conventional spectrometer can be difficult to couple directly to the industrial process line.

Due to the drawbacks of the conventional spectrometer and related equipment, material sampling is a technique of choice in many industries. In the conventional material sampling technique shown in FIG. 1, gases or liquids of interest are conveyed through elaborate sampling techniques and devices to the spectrometer, which typically is housed in a separate, protected area. As shown, optical probes and fiberoptic bundles are used in some instances to convey light from a process line to the spectroscopic instruments. However, an inability to directly couple the spectrometer to the process lines affects precise and timely process control and increases equipment cost. Sampling further limits process control and product assurance, and increases equipment and maintenance costs. Additionally, the use of probes affects measurement in spectral areas where optical fiber transmission is limited.

Even in industries in which the foregoing, cumbersome procedure can be employed with a modicum of success, technological advances eventually render presently employed spectrometers and related equipment obsolete, and cash outlays inevitably are required to update the technology.

An urgent need exists in industry process lines to avoid unnecessary capital equipment expenditures and related equipment obsolescence and depreciation.

### BRIEF SUMMARY OF THE DISCLOSURE

In general, the present invention is directed to methods of assessing a technology requirement of a customer and licensing a state-of-the-art technology option to the customer to address the technology requirement. As will be appreciated from the following detailed description, the invention and related component parts are reliable and relatively economical to develop and employ.

By way of example, the technology requirement can be a need to sample and measure production material in an industry process line in real-time, such as in pharmaceutical, environmental, chemical, petroleum (e.g., oil & gas), agriculture, plastics, government (e.g., Homeland Security), and food & beverage process lines. Exemplary methods according to the invention account for on-going product improvements and enhancements in order for a customer to avoid obsolescence and depreciation of capital equipment. Other methods of the invention provide for routine calibration and performance assurance and for hardware and peripheral equipment, firmware (i.e., coded instructions in read-only memory) and software upgrades, without service contract requirements. The invention also minimizes risks that capital equipment will fail to meet customer expectations. Moreover, a customer can avoid having to research, purchase and install updated capital equipment components and can avoid related implementation of subsequent training of customer personnel.

By way of further example, the technology option can be an optical system for multivariate optical computing in real-time in the industrial process line. Multivariate optical computing (MOC) is generally described in U.S. Pat. No. 6,198,531 B1 to Myrick et al. and in U.S. Pat. No. 6,529,276 B1 to Myrick as a predictive spectroscopy technique that incorporates a multi-wavelength spectral weighting directly into analytical instrumentation. Both of these patents are incorporated herein for all purposes by reference thereto.

The exemplary optical system technology can be applied to real-time measurements of solids, liquids, gases and their combinations across a range of industrial applications. As briefly introduced, operations with solids include, but are not limited to, monitoring blending of pharmaceutical powders, including excipients, additives, and active pharmaceutical materials; blending of other powders, including food and chemicals; monitoring and analyzing foods, including pet foods, and detecting hazardous bacteria or mold spores and the like on the food; and measuring moving powders, tablets or other compressed solids. Operations with liquids include, but are not limited to, monitoring dispersions and bi-phasic mixtures (such as emulsions); and petroleum (e.g., oil and gas) applications, including analyzing water content in oil, or oil content in water. Operations with gases include, but are not limited to, environmental applications such as stack gas analysis, including measurement of NOx, SOx, CO, CO2, or other gases in a gas stream.

Other environmental applications involving solids, liquids, gases and their combinations include, but are not limited to, wastewater analysis and treatment monitoring; hazardous substance monitoring applications such as mercury vapor detection; detecting a biohazard or chemical agent such as a poison gas or a suspended solid (e.g., anthrax). In a particular aspect of the invention, inclusion of a transmissive window provides physical separation between the measuring device and the process or material being tested. Therefore, this window allows for in-line measurement and/or non-invasive measurement of parameters such as chemical functionality, including alcohol content of petroleum fractions or tackifier resins. The skilled artisan will appreciate that multivariate optical computing is simply provided as one example of the technology option. Other options include but are not limited to interferometers, spectroscopic instruments, spectroscopic analysis software and the like.

In one embodiment of the invention, a method of licensing technology includes assessing a technology requirement of a customer; pricing an optical analysis system to meet the technology requirement; licensing the optical analysis system based on the pricing thereof for a predetermined period of time; and maintaining the optical analysis system for the predetermined period of time. The optical analysis system can include a multivariate optical computer. The optical analysis system can also include one of a software program, a hardware component, and a software and hardware suite.

More specifically, the optical analysis system can be a pharmaceutical product software program, a pharmaceutical product hardware component, a pharmaceutical product software and hardware suite, a fuel product software program, a fuel product hardware component, a fuel product software and hardware suite, a food analysis software program, a food analysis hardware component, a food analysis software and hardware suite, a chemical analysis software program, a chemical analysis hardware component, a chemical analysis software and hardware suite, a biphasic mixture monitoring software program, a biphasic mixture monitoring hardware component, a biphasic mixture software and hardware suite, a dispersion monitoring software program, a dispersion monitoring hardware component, a dispersion software and hardware suite, a stack gas analysis software program, a stack gas analysis hardware component, a stack gas analysis software and hardware suite, a hazardous substance monitoring software program, a hazardous substance monitoring hardware component, a hazardous substance monitoring software and hardware suite, a wastewater analysis and treatment software program, a wastewater analysis and treatment hardware component, or a wastewater analysis and treatment software and hardware suite.

According to this aspect of the invention, pricing of the optical analysis system is based on current pricing information; i.e., today's pricing. The pricing of the optical analysis system can be a flat fee arrangement by year, quarter, month, and/or any other fee arrangement based on a variety of time periods and payment options as desired by the customer.

Maintaining of the optical analysis system includes at least one of supporting the optical analysis system by remote communications, supporting the optical analysis system by an on-site visit to the customer, and upgrading the optical analysis system for the predetermined period of time.

The method can further include training the customer to use the upgraded optical analysis system.

The method can also include designing the optical analysis system as one of an application specific software program, an application specific hardware component, and an application specific software and hardware suite. The application specific hardware component can be a multivariate optical computer, which can be an in-line computer.

The method can include renewing the licensing of the optical analysis system after the predetermined period of time.

The method can further include installing the optical analysis system at a customer site.

The method can also include testing the optical analysis system to meet the technology requirement prior to licensing the optical analysis system.

According to another aspect of the invention, a method of licensing technology includes assessing a measurement requirement of a customer; pricing an analytical technology option to meet the measurement requirement; testing the analytical technology option to meet the measurement requirement; licensing the analytical technology option based on the pricing thereof for a predetermined period of time; and maintaining the analytical technology option for the predetermined period of time.

More specifically, the analytical technology option can be a pharmaceutical product software program, a pharmaceutical product hardware component, a pharmaceutical product software and hardware suite, a fuel product software program, a fuel product hardware component, a fuel product software and hardware suite, a food analysis software program, a food analysis hardware component, a food analysis software and hardware suite, a chemical analysis software program, a chemical analysis hardware component, a chemical analysis software and hardware suite, a biphasic mixture monitoring software program, a biphasic mixture monitoring hardware component, a biphasic mixture software and hardware suite, a dispersion monitoring software program, a dispersion monitoring hardware component, a dispersion software and hardware suite, a stack gas analysis software program, a stack gas analysis hardware component, a stack gas analysis software and hardware suite, a hazardous substance monitoring software program, a hazardous substance monitoring hardware component, a hazardous substance monitoring software and hardware suite, a wastewater analysis and treatment software program, a wastewater analysis and treatment hardware component, or a wastewater analysis and treatment software and hardware suite.

According to this aspect of the invention, pricing of the analytical technology option is based on current pricing information; i.e., today's pricing. The pricing of the analytical technology option can be a flat fee arrangement by year, quarter, month, and/or any other fee arrangement based on a variety of time periods and payment options as desired by the customer.

Maintaining of the analytical technology option includes at least one of supporting the analytical technology option by remote communications, supporting the analytical technology option by an on-site visit to the customer, and upgrading the analytical technology option for the predetermined period of time.

The method can further include training the customer to use the upgraded analytical technology option.

The method can also include designing the analytical technology option as one of an application specific software program, an application specific hardware component, and an application specific software and hardware suite. The application specific hardware component can be an in-line multivariate optical computer.

The method can further include renewing the licensing of the analytical technology option after the predetermined period of time.

The method can also include installing the analytical technology option at a customer site.

According to another aspect of the invention, a method of licensing technology includes assessing a technology requirement of a customer; pricing an optical analysis system to meet the technology requirement; testing the optical analysis system to meet the technology requirement; licensing the optical analysis system based on the pricing thereof for a predetermined period of time; and maintaining the optical analysis system for the predetermined period of time.

In this aspect of the invention, the optical analysis system includes a software program and a hardware component. Also, the optical analysis system can be an in-line multivariate optical computer.

Maintaining of the optical analysis system in this aspect of the invention includes at least one of supporting the optical analysis system by remote communications, supporting the optical analysis system by an on-site visit to the customer, and upgrading the optical analysis system for the predetermined period of time.

The method of licensing can include training the customer to use the upgraded optical analysis system.

The method of licensing can further include renewing the licensing of the optical analysis system after the predetermined period of time.

The method of licensing can also include installing the optical analysis system at a customer site.

Other features, aspects and advantages of the invention will be apparent from the following description and the attached drawings, or can be learned through practice of the invention.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic view of a conventional spectroscopic instrument application;

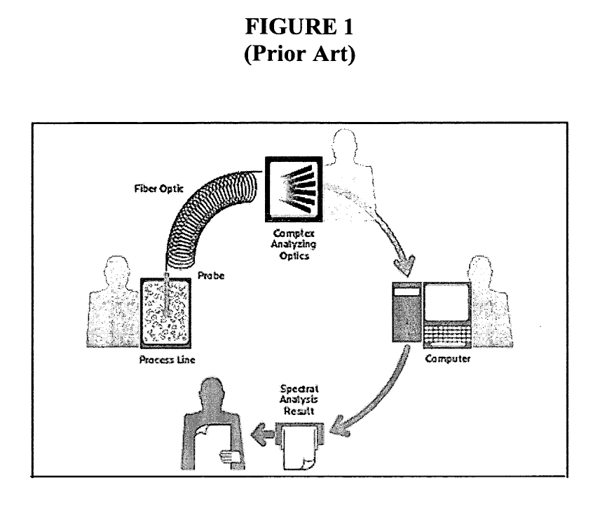

FIG. 2 is a schematic view of a method according to an aspect of the invention, particularly showing a licensed and upgradeable optical head directly coupled in a process line;

FIG. 3 is a partial, perspective view of the process line and the optical head as in FIG. 2;

FIG. 4 is a partial, top perspective view of the process line as in FIG. 3, particularly showing upgradeable elements of the optical head and other licensed, upgradeable components according to further aspects of the invention;

FIG. 5 is a perspective view of various licensed, upgradeable components according to further aspects of the present invention; and

FIG. 6 is a flow chart of a method according to another aspect of the present invention.

It is to be understood by one of ordinary skill in the art that the present discussion is a description of exemplary embodiments only and is not intended as limiting the broader aspects of the present invention.

### DETAILED DESCRIPTION OF THE DISCLOSURE

Detailed reference will now be made to the drawings in which examples embodying the present invention are shown. The detailed description uses numerical and letter designations to refer to features of the drawings. Like or similar designations of the drawings and description have been used to refer to like or similar parts of the invention.

The drawings and detailed description provide a full and written description of the invention, and of the manner and process of making and using it, so as to enable one skilled in the pertinent art to make and use it, as well as the best mode of carrying out the invention. However, the examples set forth in the drawings and detailed descriptions are provided by way of explanation only and are not meant as limitations of the invention. The present invention thus includes any modifications and variations of the following examples as come within the scope of the appended claims and their equivalents.

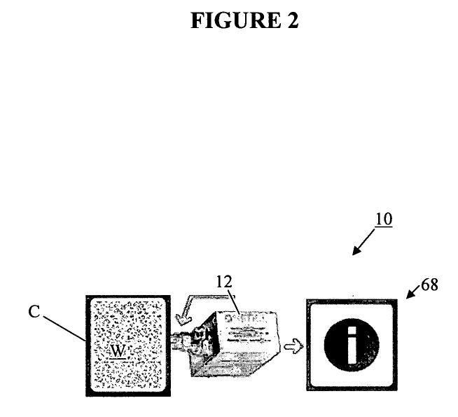

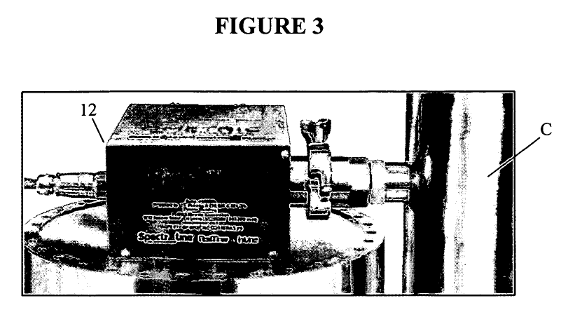

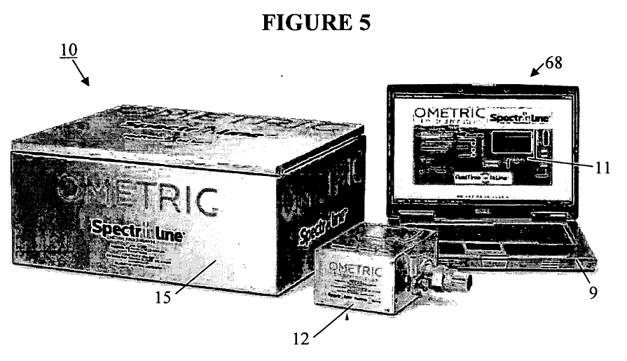

With reference to FIGS. 2-5, an optical analysis system 10 is provided as an exemplary technology option to a customer on the basis of a license agreement. As shown, the optical analysis system 10 includes an in-line, optical head or computer 12, which is installed in an industrial process line of the customer for monitoring a workpiece or sample W in a container C, e.g., monitoring blending of pharmaceutical powders. An ASMOC™ brand computer, available from OMETRIC Corporation of Columbia, S.C., is ideally suited as the optical computer 12 and described in greater detail below.

As further shown in FIGS. 2-5, a system 68 communicates with the optical computer 12 to control system parameters such as data logging, sampling time, process control feedback, or other data output requirements. These and other components are also available from OMETRIC Corporation.

As briefly introduced above, the customer can choose duration for the license agreement and be guaranteed a price of the optical analysis system 10 for that duration. In other words, a prearranged price or fee, such as a flat yearly fee, covers the use of the optical analysis system 10 for the life of the license. In this example, the license fee is flat and constant per the yearly basis for the duration of the license agreement. In exchange for the fee, the optical analysis system 10 and its separate components, as will be described in further detail below, are supported, maintained and upgraded with the latest, state-of-the-art enhancements for the duration of the license agreement. Of course, those skilled in the art will appreciate that the terms of the license agreement, such as its duration, can be modified to accommodate customer requirements; thus, the license agreement is not limited to the exemplary flat yearly fee. For example, the customer may only require use of the optical analysis system 10 for a one-time project for a calendar year quarter, and the license agreement can be drafted to reflect such alternative terms.

The license agreement is an expense for the customer, not a capital equipment investment. Thus, the customer is not affected by equipment obsolescence, cost of capital, depreciation, cost of maintenance and the like. Accordingly, the customer is assured of always having state-of-the-art performance with no worries of technology obsolescence. Moreover, there are no unanticipated expenses and no capital expenditures. According to the invention, full support and maintenance of the selected technology option are provided without separate hardware or software service contracts. Perhaps most importantly, the customer is ensured of satisfaction; i.e., there is no “buyer's remorse” if the equipment fails to meet expectations since the equipment can be upgraded or modified according to terms of the license agreement. If the equipment can not be upgraded or modified to the satisfaction of the customer, then the equipment can be returned and the license agreement cancelled.

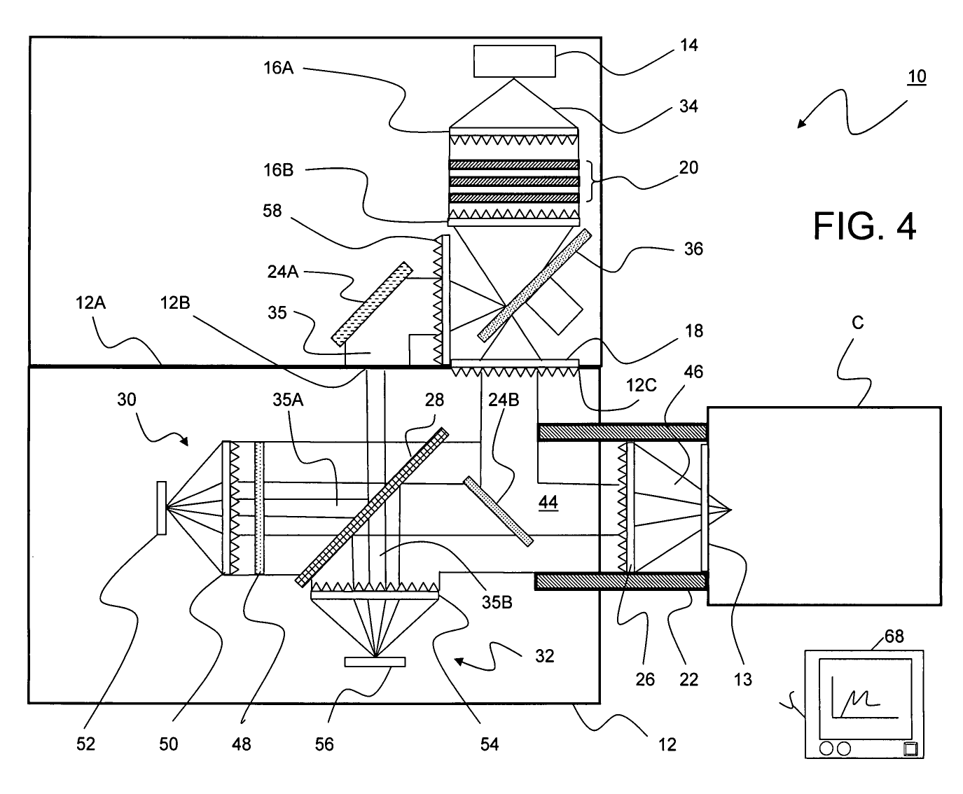

With particular reference now to FIG. 4, the optical analysis system 10 introduced above includes the optical head 12, an illumination or light source 14, a chopper wheel 36, a plurality of spectral elements 20, a focusing lens 26, a beam splitter 28, a first detector 30 including a multivariate optical element 48 and a second detector 32. As shown, the illumination source 14 provides a light 34, which passes through a collecting Fresnel lens 16A and into and through the spectral element(s) 20. In this example, the illumination source 14 is rated for at least about 10,000 hours of operation, which alleviates a need for redundant illumination sources, though they may be provided if desired. Also in this example, the collecting Fresnel lens 16A is sized to be about 1.5 square inches and is spaced about 0.6 inches from the illumination source 14. The skilled artisan will instantly recognize that these dimensions can be adjusted according to particular system requirements and are not meant as limitations of the invention.

As shown in FIG. 4, light 34 passes through the spectral elements 20, which filter out undesired wavelengths in order to bound a desired spectral region, e.g., 1500-2000 nm, in order to target a particular chemical material of interest. Light 34 is focused by focusing Fresnel lens 16B, which is also sized to be about 1.5 square inches and spaced about 1 inch to about 3 inches from the chopper wheel 136. As shown, the chopper wheel 36 reflects a portion of light 34 as a calibration or reference light 35 and a transmitted light 44. Calibration light 35 is collimated by lens 58 before reflecting from a first mirror 24A through an adjustable aperture 12B in a bulkhead 12A of the optical head 12. The aperture 12B is adjustable to dictate a desired amount of the calibration light 35. Finally, calibration light 35 impinges on beam splitter 28 thereby sending a portion 35A of calibration light 35 to the first MOE detector 52 and a portion 35B of calibration light 35 to the second or baseline detector 56.

FIG. 4 further illustrates that transmitted light 44 passes from the chopper wheel 36 into a collimating Fresnel lens 18, which in this example is sized to be about 1.5 square inches and is spaced from about 0.5 to about 1.5 inches from the chopper wheel 36. The transmitted light 44 passes through another adjustable aperture 12C in the bulkhead 12A and impinges upon a second mirror 24B, which directs the transmitted light 44 toward a sample in a container C, such as mixing vat or blender. The skilled artisan will recognize that the container could be a conveyor belt or other device for holding or transporting the sample and is not limited to an enclosed container.

As shown in FIG. 4, the transmitted light 44 is focused by the focusing Fresnel lens 26, which in this example may be round and about 1 inch in diameter and is adjustable with an inner tube 22. Also in this example, lens 26 may be positioned about 0.6 inches from an outer surface of the container C. As shown, the transmitted light 44, now focused, passes through a transmissive window 13, which in this example is approximately 1 inch in diameter and includes an anti-reflective (AR) coating on either or both sides. The window 13 provides a physical separation between the system 10 and a chemical process in the container C to ensure that the chemical process does not interfere with the measuring process of the optical analysis system 10, and likewise that the electrical functions of the system 10 do not interfere with the chemical process. The AR coating improves the signal by reducing interfering reflectances.

As further shown in FIG. 4, the transmitted light 44 enters the container C and reflects from the sample as a carrier light 46. Those skilled in the art will appreciate that the sample can be a moving mixture such as a chemical mixture, a pharmaceutical blend, a food process, a chemical process; more specifically, such as an aspirin and an excipient being blended in real time, or a plurality of tablets passing by on a conveyor belt at high speed, or milk mixed with vitamins.

FIG. 4 further illustrates that the carrier light 46 is directed by the tube 22 in a direction of the first detector 30. Eventually, the carrier light 46 impinges on the beam splitter 28 and a portion passes in a direction of the detector 32 for baselining with the portion 35B of the calibration light 35. Another portion of the carrier light 46 passes through MOE 48, which as noted above, has been designed based on the chemical(s) of interest and the various components of the system 10. Finally, that portion of the carrier light 46, having passed through the MOE 48, is focused by lens 50 and received by the detector 52. As described above, the two signals collected by the detectors 32 and 52 can be manipulated, e.g., mathematically, to extract and ascertain information about the sample carried by the carrier light 46.

Various detectors such as PbSe, PbS, Si, Ge, InAs, InGaAs, HgCdTe and the like are suitable for use as the detectors 52,56 in the optical analysis system 10. As with any component of the optical analysis system 10, these detectors 52, 56 can be specifically identified as replacement or upgradeable items in the license agreement according to the invention.

As further shown in FIG. 4, a gain mechanism 64 is in communication with the detectors 30, 32 and the MOE 48. The gain mechanism 64 weights a magnitude of the property of an orthogonal component of a portion of the carrier light 48 as described, for instance, by Myrick et al. in U.S. Pat. No. 6,198,531 B1 and in U.S. Pat. No. 6,529,276 B1 to Myrick, which are both incorporated herein by reference thereto.

Also, in an additional aspect of the invention as shown in FIG. 4, the system 68 using an electrochemical or chemometric model can be employed to make similar or same measurements of the light 46 reflected from the sample W as the measurements described in the foregoing embodiments. By way of example but not of limitation, the system 68 may be one as described by Myrick et al. in PCT Application Number PCT/US2004/043742, based on U.S. Provisional Application No. 60/533,570, filed Dec. 31, 2003, which are incorporated herein by reference to these applications.

Due to variations in system optical and electronic performance combined with changes in sample reflectance, the optical analysis system 10 may use a reference signal (and detector) to account for those variations. For a system with small such variation, it would be possible to use a single detector (with the MOE). In this case, the response from the reference detector would be considered a constant.

Specifically, for improved detector performance, the light signal can be modulated by continuously monitoring the intensity of a beam of light. The easiest way to achieve this is to allow the beam to impinge upon some kind of photo-electric detector (such as a photo-diode or photo-multiplier tube) and monitor the resultant electrical output. If the light beam is very weak then the electrical output from the photo-detector will be very small and therefore some sort of amplification of this signal will be required.

A continuous optical beam will create a DC signal at the output of the photo-detector so any subsequent amplifier used to increase this signal level will need to be capable of amplifying DC. Although this is perfectly feasible, DC amplifiers do suffer from drift due to temperature fluctuations. This is particularly evident in high gain amplifiers. Also any other perturbation of the signal due to other stimuli (stray light for example) will also be amplified and appear as genuine output.

If the signal of interest (that is the original light beam) could be made to act as an AC signal then the detector output would be AC and any further amplification could be carried out with an AC (only) amplifier. AC amplifiers do not suffer from temperature drift and will not respond to DC signals. So the only signal that would be amplified is that due to the (AC) light beam. To make a light beam act in an AC manner it needs to be turned on and off regularly and accurately. This can be achieved by chopping.

The most common technique is to pass the beam through a rotating disk that has holes or slots cut into it at regular intervals. As the disk rotates it “chops” the beam producing an on/off signal which when detected by a photo-detector will appear as an AC signal.

The mechanical chopping of the light beam is very precisely controlled by the chopper and therefore the resultant AC signal due to the chopped light is at a known and stable frequency which can be monitored and amplified easily.

The operating principle of a photoelastic modulator (PEM) modulates light polarization which manifests the photoelastic effect in which a mechanically stressed sample exhibits optical birefringence.

In addition to the reflectance mode described above, one or more optical analysis systems can operate in a transmission mode in conjunction with the foregoing embodiments. In such a case, light is directed (passes) through the sample W, e.g., a fluid sample, and collected on another side of the sample W to enable study of particle density in the fluid in conjunction with the chemical content described above. For instance, the system 10 can be configured to operate in transmission mode where the light is shone through the sample W to a similar detection system as shown in FIG. 4. Additionally, or alternatively, a mirrored surface can be placed within the transmissive sample W to reflect the light back into the system 10.

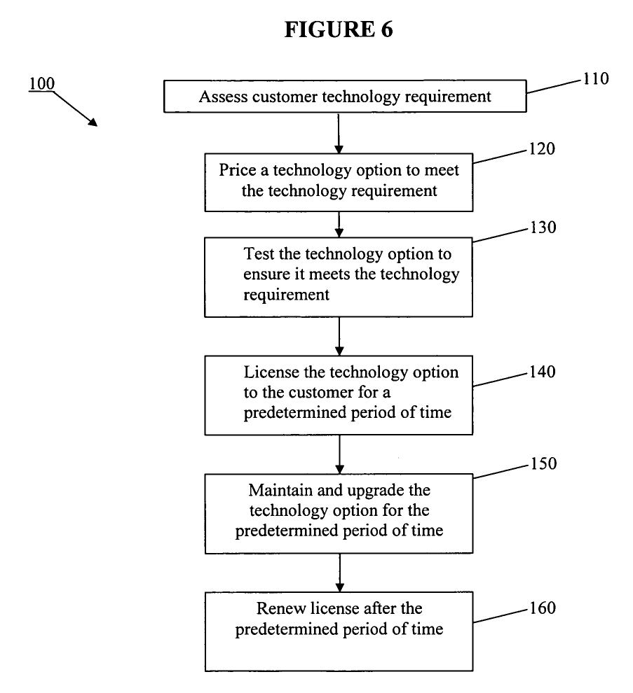

The present invention may be better understood with reference to the following example and to FIG. 6.

Real-Life Example: Cost of Equipment Ownership

Purchase price of capital equipment: $100,000

* Annual maintenance: $15,000

Annual cost of capital to purchase capital equipment: 7%

Total cost after 4 years: $202,000

Failure to upgrade capital equipment based on technological advances:

Unknowable but probably a poor business decision (good for competitors).

Thus, owning capital equipment has surreptitious and unknowable costs, which add up to significantly more than just the purchase price of the equipment.

As shown in FIG. 6, the costs of purchasing and owning capital equipment can be avoided according to an aspect of the invention in which a licensing arrangement process 100 includes assessing a customer technology requirement (110), pricing a technology option such as an optical system to meet the technology requirement (120), testing the technology option to ensure it meets the technology requirement (130), licensing the technology option to the customer for a predetermined period of time (140), and maintaining and upgrading the technology option for the predetermined period of time (150). The license can also be renewed or upgraded for the same or additional technology option(s) after the predetermined period of time expires (160).

Although the invention has been described in such a way as to provide an enabling disclosure for one skilled in the art to make and use the invention, it should be understood that the descriptive examples of the invention are not intended to limit the present invention to use only as shown in the figures. For instance, the optical head 12 can be shaped as a square, an oval, or in a variety of other shapes. Further, a variety of light sources can be substituted for those described above. It is intended to claim all such changes and modifications as fall within the scope of the appended claims and their equivalents. Thus, while exemplary embodiments of the invention have been shown and described, those skilled in the art will recognize that changes and modifications may be made to the foregoing examples without departing from the scope and spirit of the invention.

That which is claimed is:

1. A method of licensing technology, comprising:
assessing a technology requirement of a customer;
pricing an optical analysis system to meet the technology requirement;
licensing the optical analysis system based on the pricing thereof for a predetermined period of time; and
maintaining the optical analysis system for the predetermined period of time.

2. The method of licensing as in claim 1, wherein the optical analysis system includes one of a software program, a hardware component, and a software and hardware suite.

3. The method of licensing as in claim 1, wherein the optical analysis system includes one of a pharmaceutical product software program, a pharmaceutical product hardware component, and a pharmaceutical product software and hardware suite.

4. The method of licensing as in claim 1, wherein the optical analysis system includes one of a fuel product software program, a fuel product hardware component, and a fuel product software and hardware suite.

5. The method of licensing as in claim 1, wherein the optical analysis system includes one of a food analysis software program, a food analysis hardware component, and a food analysis software and hardware suite.

6. The method of licensing as in claim 1, wherein the optical analysis system includes one of a chemical analysis software program, a chemical analysis hardware component, and a chemical analysis software and hardware suite.

7. The method of licensing as in claim 1, wherein the optical analysis system includes one of a biphasic mixture monitoring software program, a biphasic mixture monitoring hardware component, and a biphasic mixture software and hardware suite.

8. The method of licensing as in claim 1, wherein the optical analysis system includes one of a dispersion monitoring software program, a dispersion monitoring hardware component, and a dispersion software and hardware suite.

9. The method of licensing as in claim 1, wherein the optical analysis system includes a multivariate optical computer.

10. The method of licensing as in claim 1, wherein the optical analysis system includes one of a stack gas analysis software program, a stack gas analysis hardware component, and a stack gas analysis software and hardware suite.

11. The method of licensing as in claim 1, wherein the optical analysis system includes one of a hazardous substance monitoring software program, a hazardous substance monitoring hardware component, and a hazardous substance monitoring software and hardware suite.

12. The method of licensing as in claim 1, wherein the optical analysis system includes one of a wastewater analysis and treatment software program, a wastewater analysis and treatment hardware component, and a wastewater analysis and treatment software and hardware suite.

13. The method of licensing as in claim 1, wherein the pricing of the optical analysis system is based on current pricing information.

14. The method of licensing as in claim 1, wherein the pricing of the optical analysis system is a flat fee arrangement.

15. The method of licensing as in claim 1, wherein the maintaining of the optical analysis system includes at least one of supporting the optical analysis system by remote communications, supporting the optical analysis system by an on-site visit to the customer, and upgrading the optical analysis system for the predetermined period of time.

16. The method of licensing as in claim 15, further comprising training the customer to use the upgraded optical analysis system.

17. The method of licensing as in claim 1, further comprising designing the optical analysis system as one of an application specific software program, an application specific hardware component, and an application specific software and hardware suite.

18. The method of licensing as in claim 17, wherein the application specific hardware component is a multivariate optical computer.

19. The method of licensing as in claim 18, wherein the multivariate optical computer is an in-line computer.

20. The method of licensing as in claim 1, further comprising renewing the licensing of the optical analysis system after the predetermined period of time.

21. The method of licensing as in claim 1, further comprising installing the optical analysis system at a customer site.

22. The method of licensing as in claim 1, further comprising testing the optical analysis system to meet the technology requirement prior to licensing the optical analysis system.

23. A method of licensing technology, comprising:
assessing a measurement requirement of a customer;
pricing an analytical technology option to meet the measurement requirement;
testing the analytical technology option to meet the measurement requirement;
licensing the analytical technology option based on the pricing thereof for a predetermined period of time; and
maintaining the analytical technology option for the predetermined period of time.

24. The method of licensing as in claim 23, wherein the analytical technology option is one of a software program, a hardware component, and a software and hardware suite.

25. The method of licensing as in claim 23, wherein the analytical technology option is one of a pharmaceutical product software program, a pharmaceutical product hardware component, and a pharmaceutical product software and hardware suite.

26. The method of licensing as in claim 23, wherein the analytical technology option is one of a fuel product software program, a fuel product hardware component, and a fuel product software and hardware suite.

27. The method of licensing as in claim 23, wherein the analytical technology option is one of a food analysis software program, a food analysis hardware component, and a food analysis software and hardware suite.

28. The method of licensing as in claim 23, wherein the analytical technology option is one of a biphasic mixture monitoring software program, a biphasic mixture monitoring hardware component, and a biphasic mixture software and hardware suite.

29. The method of licensing as in claim 23, wherein the analytical technology option is one of a dispersion monitoring software program, a dispersion monitoring hardware component, and a dispersion software and hardware suite.

30. The method of licensing as in claim 23, wherein the analytical technology option is an optical analysis system.

31. The method of licensing as in claim 23, wherein the analytical technology option is one of a stack gas analysis software program, a stack gas analysis hardware component, and a stack gas analysis software and hardware suite.

32. The method of licensing as in claim 23, wherein the analytical technology option is one of a hazardous substance monitoring software program, a hazardous substance monitoring hardware component, and a hazardous substance monitoring software and hardware suite.

33. The method of licensing as in claim 23, wherein the analytical technology option is one of a wastewater analysis and treatment software program, a wastewater analysis and treatment hardware component, and a wastewater analysis and treatment software and hardware suite.

34. The method of licensing as in claim 23, wherein the pricing of the analytical technology option is based on current pricing information.

35. The method of licensing as in claim 23, wherein the pricing of the analytical technology option is a flat fee arrangement.

36. The method of licensing as in claim 23, wherein the maintaining of the analytical technology option includes at least one of supporting the analytical technology option by remote communications, supporting the analytical technology option by an on-site visit to the customer, and upgrading the analytical technology option for the predetermined period of time.

37. The method of licensing as in claim 36, further comprising training the customer to use the upgraded analytical technology option.

38. The method of licensing as in claim 23, further comprising designing the analytical technology option as one of an application specific software program, an application specific hardware component, and an application specific software and hardware suite.

39. The method of licensing as in claim 38, wherein the application specific hardware component is a multivariate optical computer.

40. The method of licensing as in claim 39, wherein the multivariate optical computer is in-line.

41. The method of licensing as in claim 40, further comprising renewing the licensing of the analytical technology option after the predetermined period of time.

42. The method of licensing as in claim 41, further comprising installing the analytical technology option at a customer site.

43. A method of licensing technology, comprising:
assessing a technology requirement of a customer;
pricing an optical analysis system to meet the technology requirement;
testing the optical analysis system to meet the technology requirement;
licensing the optical analysis system based on the pricing thereof for a predetermined period of time; and
maintaining the optical analysis system for the predetermined period of time.

44. The method of licensing as in claim 43, wherein the optical analysis system includes a software program and a hardware component.

45. The method of licensing as in claim 43, wherein the optical analysis system is an in-line multivariate optical computer.

46. The method of licensing as in claim 43, wherein the maintaining of the optical analysis system includes at least one of supporting the optical analysis system by remote communications, supporting the optical analysis system by an on-site visit to the customer, and upgrading the optical analysis system for the predetermined period of time.

47. The method of licensing as in claim 46, further comprising training the customer to use the upgraded optical analysis system.

48. The method of licensing as in claim 43, further comprising renewing the licensing of the optical analysis system after the predetermined period of time.

49. The method of licensing as in claim 43, further comprising installing the optical analysis system at a customer site.
